(19) United States
(12) Patent Application Publication
(10) Pub. No.: US 2014/0143701 A1
(43) Pub. Date: May 22, 2014

(54) VISUALIZING RELATED BUSINESS ACTIVITIES IN AN INTERACTIVE TIMELINE

(71) Applicant: Timo Hoyer, South San Francisco, CA (US)

(72) Inventor: Timo Hoyer, South San Francisco, CA (US)

(21) Appl. No.: 13/682,120

(22) Filed: Nov. 20, 2012

(51) Int. Cl. G06F 3/0484

(52) U.S. Cl. CPC G06F 3/0484
USPC 715/772

(57) ABSTRACT

The disclosure generally describes computer-implemented methods, software, and systems for displaying business-related information. A computer-implemented method includes operations for identifying a set of business activities associated with an account, wherein at least one of the business activities is associated with a business process, generating an account activity visualization for the account, the account activity visualization including a plurality of business activities associated with the account, providing the account activity visualization to a user for display, receiving a user selection of a particular business activity from the plurality of business activities included in the account activity visualization, identifying at least one business activity related to the selected particular business activity, and updating the account activity visualization to visually distinguish the selected particular business activity and the at least one related business activity to visually indicate their relation in the account activity visualization.

### TECHNICAL FIELD

The present disclosure relates to computer-implemented methods, software, and systems for presenting information for related activities.

### BACKGROUND

In a business environment, many business-related activities can occur, some of which being related to one or more previous and future business-related activities. In some instances, related business activities can be directly associated with each other, such as through a common connection of a single business process, while in others, activity associations may be unclear or otherwise difficult to determine. Further, large amounts of related data (e.g., sales, customers, contracts, etc.) can exist across one or more processes, applications, or systems, with no efficient way of visualizing related pieces of the data. For example, a document created by a sales representative today, such as a sales order, can be based on several steps in an ongoing process that can include activities that occurred today, yesterday and/or weeks ago. Similarly, documents and/or activities created in the future, such as contracts, may be based on that newly created document. The complete set of business-related activities can be thought of as a chain of related activities.

### SUMMARY

The present disclosure relates to computer-implemented methods, software, and systems for visualizing related business activities in an interactive timeline. One example process includes operations for identifying a set of business activities associated with an account, wherein at least one of the business activities of the set of business activities is associated with a business process, generating an account activity visualization for the account, the account activity visualization including a plurality of business activities associated with the account, providing the account activity visualization to a user for display, receiving a user selection of a particular business activity from the plurality of business activities included in the account activity visualization, identifying at least one business activity of the plurality of business activities included in the account activity visualization related to the selected particular business activity, and updating the account activity visualization to visually distinguish the selected particular business activity and the at least one related business activity to visually indicate their relation in the account activity visualization.

While generally described as computer implemented software embodied on tangible media that processes and transforms the respective data, some or all of the aspects may be computer implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 illustrates an example environment for providing an account activity visualization.

FIG. 2 is an example illustration of an example interface that displays an account activity visualization that can occur using a system such as the one illustrated in FIG. 1.

FIG. 3A is another example illustration of the example interface that changes the display of the account activity visualization based on a user selection.

FIG. 3B is another example illustration of the example interface showing a faded view.

FIG. 3C is another example illustration of the example interface showing a collapsed view.

FIG. 4 is an example illustration of an example details display for an entry in the account activity visualization.

FIG. 5 is a flowchart of an example method for creating an account activity visualization.

FIG. 6 is a flowchart of another example method for creating an account activity visualization.

### DETAILED DESCRIPTION

The present disclosure relates to computer-implemented methods, software, and systems for providing an account activity visualization. Generally, the present disclosure describes methods for displaying a set of business-related activities, e.g., in a timeline, and enabling a user to manipulate the visualization. For example, the timeline may provide to the user a quick glance at all of the business-related activities related to a particular user-selected account. The user can then select one of the activities in the visualization, and, in response, the visualization can change to visually distinguish (e.g., emphasize or highlight) all other activities that are related to the selected one. Other ways of producing and changing the visualization can occur. Visually identifying a chain of business-related activities from a larger group of activities can provide a user with temporal and other information about activities in the chain of business-related activities.

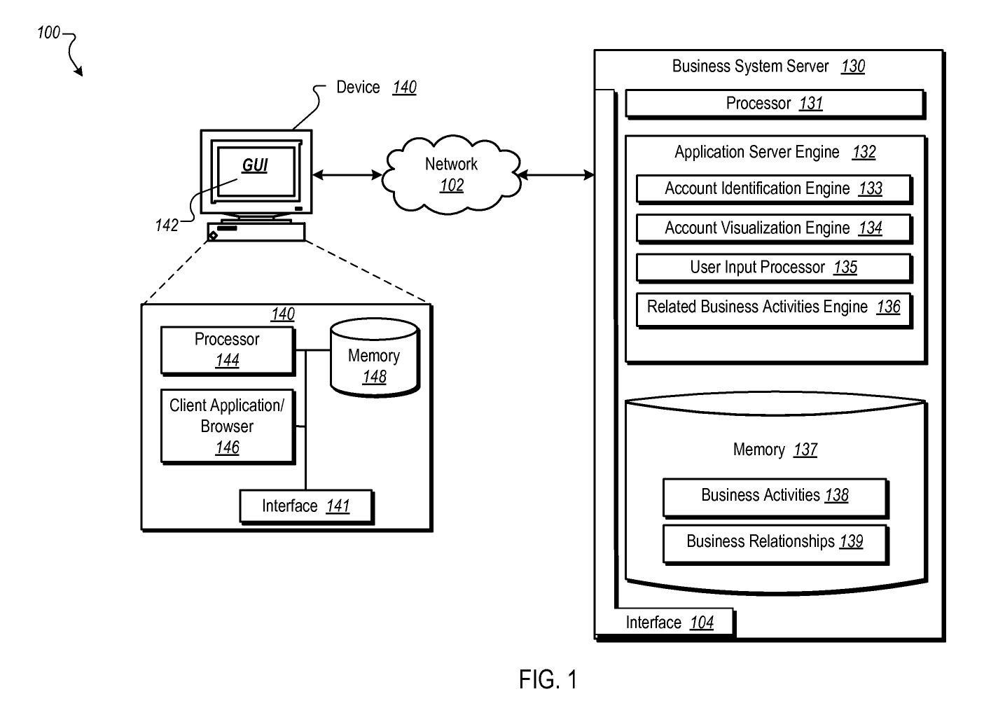

FIG. 1 illustrates an example environment 100 for providing an account activity visualization. Specifically, the illustrated environment 100 includes, or is communicably coupled with, a business system server 130 and a device 140 by which a user can access resources of the business system server 130. For example, a user using the device 140 may access and use resources on the business system server 130 that are related to payroll, accounting, customer resource management, purchasing/sales, inventory, business objects, or any other suitable applications and/or systems or an enterprise system. Specifically, the business system server 130 can provide information so that a user can view an account activity visualization that includes entries representing account activities. Alternative implementations may provide a visualization of alternative sets of business or non-business data as needed.

In general, the business system server 130 is a system and/or server that provides access to business-related applications, and that can be interfaced by the device 140 to interact with the services. For example, a user using the device 140 can access information that is processed by the business system server 130. In some implementations, the business system server 130 may comprise a Web server, one or more Web-based applications accessed and executed by the device 140 via the network 102. At a high level, the business system server 130 comprises an electronic computing device operable to receive, transmit, process, store, or manage data and information associated with the environment 100.

As used in the present disclosure, the term “computer” is intended to encompass any suitable processing device. For example, although FIG. 1 illustrates a single business system server 130, the environment 100 can be implemented using two or more business system servers 130, as well as computers other than servers, including a server pool. Indeed, the business system server 130 may be any computer or processing device such as, for example, a blade server, general-purpose personal computer (PC), Macintosh, workstation, UNIX-based workstation, or any other suitable device. In other words, the present disclosure contemplates computers other than general purpose computers, as well as computers without conventional operating systems. Further, illustrated business system server 130 may be adapted to execute any operating system, including Linux, UNIX, Windows, Mac OS®, Java™, Android™, iOS or any other suitable operating system. According to one implementation, the business system server 130 may also include, or be communicably coupled with, an e-mail server, a Web server, a caching server, a streaming data server, and/or other suitable server.

The business system server 130 also includes an interface 104, an application server engine 132, and a memory 137. The interface 104 is used by the business system server 130 for communicating with other systems in a distributed environment—including within the environment 100—connected to the network 102 (e.g., the device 140), as well as other systems (not illustrated) communicably coupled to the network 102. Generally, the interface 104 comprises logic encoded in software and/or hardware in a suitable combination and operable to communicate with the network 102. More specifically, the interface 104 may comprise software supporting one or more communication protocols associated with communications such that the network 102 or interface's hardware is operable to communicate physical signals within and outside of the illustrated environment 100.

As illustrated in FIG. 1, the business system server 130 includes a processor 131. Although illustrated as a single processor 131 in FIG. 1, two or more processors 131 may be used according to particular needs, desires, or particular implementations of the environment 100. Each processor 131 may be a central processing unit (CPU), a blade, an application specific integrated circuit (ASIC), a field-programmable gate array (FPGA), or another suitable component. Generally, the processor 131 executes instructions and manipulates data to perform the operations of the business system server 130. The processor 131 also interprets state and status information. For example, the processor 131 components can interpret error codes associated with launching applications, e.g., through JavaScript, etc., as to what the issue is. The processor 131 executes the functionality required to receive and respond to requests from the device 140.

The business system server 130 includes an application server engine 132 which includes applications that provide business-related functionality, e.g., for users of devices 140. Operations of the application server engine 132 are executed by the processor 131. The application server engine 132 includes an account identification engine 133, an account visualization engine 134, a user input processor 135, and a related business activities engine 136. The account identification engine 133 is a program, application, module, or other software that identifies an account, where the identified account is associated with one or more business activities, users, clients and/or customers, e.g., specified by the user on the device 140.

The account visualization engine 134 generates information (e.g., in the form of instructions) for displaying a business account visualization, e.g., on the device 140. For example, the visualization can include displaying at least a portion of the business activities associated with the identified account. A portion may be displayed, for example, due to display size limitations of the device, e.g., if not all of the business activity information can fit on the screen at once.

The user input processor 135 can receive user inputs (e.g., received from the device 140) and determine actions to be taken with regards to the visualization based on the user's inputs. For example, if the user scrolls the business account visualization to the left or right, then the user input processor 135 can change the information to be displayed. In another example, if the user selects a particular one of the business activities in the business account visualization, then the user input processor 135 can make adjustments to the business account visualization, such as highlighting the selected business account and other related business accounts. Other actions of the user input processor 135 are possible, such as to display additional information that is related to the business account visualization.

The related business activities engine 136 can identify, for particular activities, existing related business activities. For example, the identified related business activities can be activities for a particular business activity selected by the user from the account activity visualization. For example, the related business activities engine 136 can identify leads and sales-related activities associated with a contract-related business activity selected by the user. In another example, the related business activities engine 136 can identify all of the business activities that resulted from a particular lead.

The business system server 130 also includes a memory 137, or multiple memories 137. The memory 137 may include any type of memory or database module and may take the form of volatile and/or non-volatile memory including, without limitation, magnetic media, optical media, random access memory (RAM), read-only memory (ROM), removable media, or any other suitable local or remote memory component. The memory 137 may store various objects or data, including caches, classes, frameworks, applications, backup data, business objects, jobs, web pages, web page templates, database tables, repositories storing business and/or dynamic information, and any other appropriate information including any parameters, variables, algorithms, instructions, rules, constraints, or references thereto associated with the purposes of the business system server 130. Additionally, the memory 137 may include any other appropriate data, such as VPN applications, firmware logs and policies, firewall policies, a security or access log, print or other reporting files, as well as others.

The memory 137 includes business activities 138 and business relationships 139. Business activities 138 can include information about past business-related events that have occurred relative to an account or other grouping of activities. For example, business activities related to an account for a heating company can include information about business leads and opportunities, sales quotes, sales orders and contracts, to name a few. Business relationships 139 can include information that identifies relationships among the business activities 138. For example, for a given contract, the business relationships 139 can identify one or more of leads, opportunities, sales quotes and sales orders that are related to a particular contract. Other components within the memory 137 are possible.

The illustrated environment of FIG. 1 also includes the device 140, or multiple devices 140. The device 140 may be any suitable computing device operable to connect to, or communicate with, at least the business system server 130 via the network 102 using a wire-line or wireless connection. In general, the device 140 comprises an electronic computer device operable to receive, transmit, process, and store any appropriate data associated with the environment 100 of FIG. 1.

The illustrated device 140 further includes a client application/browser 146. The client application/browser 146 is any appropriate type of application that allows the device 140 to request and view content on the device 140. In some implementations, the client application/browser 146 can be and/or include a Web browser. In some implementations, the client application/browser 146 can use parameters, metadata, and other information received at launch to access a particular set of data from the business system server 130. Once a particular client application/browser 146 is launched, a user may interactively process a task, event, or other information associated with the business system server 130. Further, although illustrated as a single client application/browser 146, the client application/browser 146 may be implemented as multiple client applications in the device 140.

The illustrated device 140 further includes an interface 141, a processor 144, and a memory 148. The interface 141 is used by the device 140 for communicating with other systems in a distributed environment—including within the environment 100—connected to the network 102; for example, the business system server 130, as well as other systems communicably coupled to the network 102 (not illustrated). Generally, the interface 141 comprises logic encoded in software and/or hardware in a suitable combination and operable to communicate with the network 102. More specifically, the interface 141 may comprise software supporting one or more communication protocols associated with communications such that the network 102 or interface's hardware is operable to communicate physical signals within and outside of the illustrated environment 100.

Regardless of the particular implementation, “software” may include computer-readable instructions, firmware, wired and/or programmed hardware, or any suitable combination thereof on a tangible medium (transitory or non-transitory, as appropriate) operable when executed to perform at least the processes and operations described herein. Indeed, each software component may be fully or partially written or described in any appropriate computer language including C, C++, Java™, Visual Basic, assembler, Perl®, any suitable version of 4GL, as well as others. While portions of the software illustrated in FIG. 1 are shown as individual modules that implement the various features and functionality through various objects, methods, or other processes, the software may instead include a number of sub-modules, third-party services, components, libraries, and such, as appropriate. Conversely, the features and functionality of various components can be combined into single components as appropriate.

As illustrated in FIG. 1, the device 140 includes the processor 144. Although illustrated as the single processor 144 in FIG. 1, two or more processors 144 may be used according to particular needs, desires, or particular implementations of the environment 100. Each processor 144 may be a central processing unit (CPU), an application specific integrated circuit (ASIC), a field-programmable gate array (FPGA), or another suitable component. Generally, the processor 144 executes instructions and manipulates data to perform the operations of the device 140. Specifically, the processor 144 executes the functionality required to send requests to the business system server 130 and to receive and process responses from the business system server 130.

The illustrated device 140 also includes a memory 148, or multiple memories 148. The memory 148 may include any memory or database module and may take the form of volatile or non-volatile memory including, without limitation, magnetic media, optical media, random access memory (RAM), read-only memory (ROM), removable media, or any other suitable local or remote memory component. The memory 148 may store various objects or data, including caches, classes, frameworks, applications, backup data, business objects, jobs, web pages, web page templates, database tables, repositories storing business and/or dynamic information, and any other appropriate information including any parameters, variables, algorithms, instructions, rules, constraints, or references thereto associated with the purposes of the device 140. Additionally, the memory 148 may include any other appropriate data, such as VPN applications, firmware logs and policies, firewall policies, a security or access log, print or other reporting files, as well as others.

There may be any number of devices 140 associated with, or external to, the environment 100. For example, while the illustrated environment 100 includes one device 140, alternative implementations of the environment 100 may include multiple devices 140 communicably coupled to the business system server 130 and/or the network 102, or any other number suitable to the purposes of the environment 100. Additionally, there may also be one or more additional devices 140 external to the illustrated portion of environment 100 that are capable of interacting with the environment 100 via the network 102. Further, the term “client” and “user” may be used interchangeably as appropriate without departing from the scope of this disclosure. Moreover, while the device 140 is described in terms of being used by a single user, this disclosure contemplates that many users may use one computer, or that one user may use multiple computers.

The illustrated device 140 is intended to encompass any suitable computing device such as a smart phone, tablet computing device, PDA, desktop computer, laptop/notebook computer, wireless data port, one or more processors within these devices, or any other suitable processing device. For example, the device 140 may comprise a computer that includes an input device, such as a keypad, touch screen, or other device that can accept user information, and an output device that conveys information associated with the operation of the business system server 130 or the device 140 itself, including digital data, visual information, or a GUI 142, as shown with respect to the device 140.

Further, the illustrated device 140 includes the GUI 142. The GUI 142 interfaces with at least a portion of the environment 100 for any suitable purpose, including generating a visual representation of a Web browser. In particular, the GUI 142 may be used to view and navigate various Web pages located both internally and externally to the business system server 130. The GUI 142 further generates a visual representation of the client application/browser 146 that executes on the device 140.

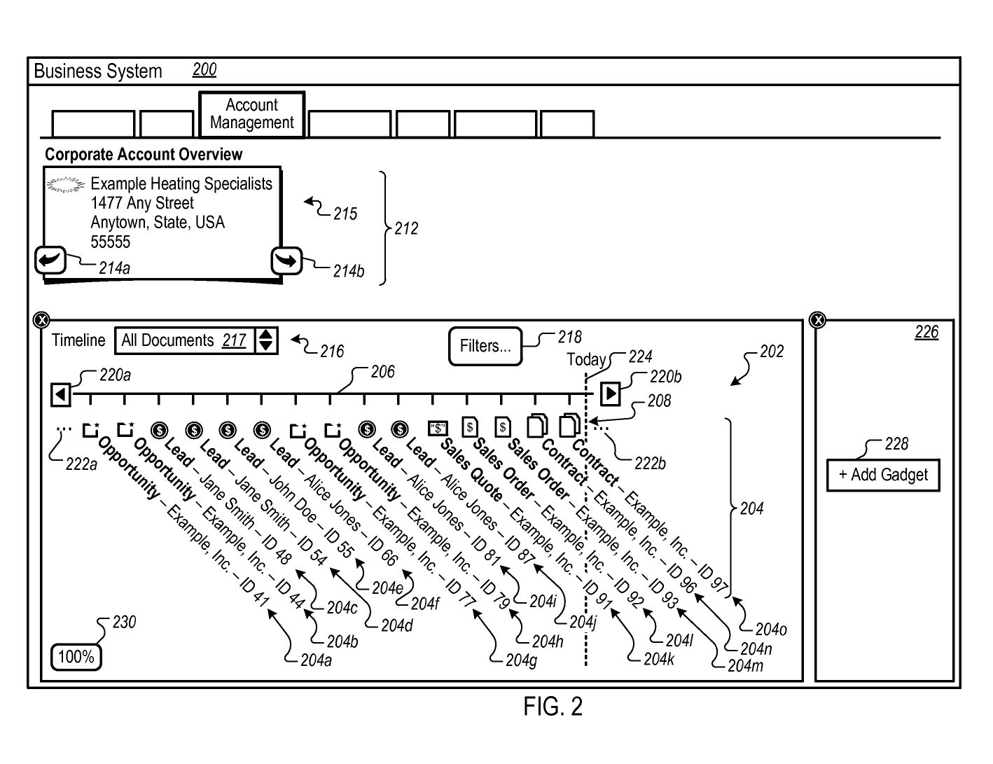

FIG. 2 is an example illustration of an example interface 200 that displays an account activity visualization 202 that can occur using a system such as the one illustrated in FIG. 1. Any suitable organization or implementation of some, all, or additional components within environment 100 may be used. This example illustration is meant to be illustrative, but not exhaustive, and alternative implementations may be used as appropriate.

The account activity visualization 202 includes business activities 204, e.g., displayed as entries in a timeline 206. For example, the business activities 204, presented in chronological order, can be associated with at least one business process associated with the account. Each business activity 204 can include, for example, an activity type (e.g., shown in FIG. 2 as bolded), a name (e.g., customer, contact, etc.) and an identifier (e.g., a unique identifier). In some implementations, the entries can be displayed diagonally as shown, e.g., at a 45-degree angle or some other angle relative to the timeline 206. In some implementations, a control can exist for displaying diagonally-displayed information in a horizontal format. For example, the user can select a click or hover control an entry presented diagonally, and the information can appear horizontally somewhere on the screen.

Different types of business activities 204 can be displayed, e.g., opportunities 204a-204b and 204g-204h, leads 204c-204f and 204i-204j, a sales quote 204k, sales orders 204l-204m, and contracts 204n-204o. In some implementations, different symbols 208 can be used to represent the different types of business activities 204. The business activities 204 are just a few examples of several business activities 204 that can be displayed, and other types of business activities can exist, such as purchase orders, shipments and payments, and other activities associated with business processes.

In some implementations, when business activities 204 are initially displayed, one or more of the business activities may be visually distinguished. The one or more business activities may be displayed in various sizes, in various colors, highlighted and the like. For example, if leads that ultimately result in a contract are considered an important business activity, then those lead entries can be displayed using a larger font than other entries. In some implementations, user-configurable settings can be used to control how business activities 204 are displayed in various ways. The settings can also identify how displays are affected based on other factors, e.g., the monetary (e.g., dollar) amount associated with a contract or other business activity. In some instances, administrators, managers, and other appropriate employees may identify particular activities as a high, medium, low, or other importance. In some instances, the importance of a particular activity may change based on the particular entity or business associated with the activity.

The entries that are selected to be displayed in the account activity visualization 202 can be determined in different ways, e.g., selected automatically and/or based on user inputs. For example, using one or more selection controls 212, a user can select from one or more categories of users, clients, customers and/or other entities. In some implementations, controls 214a and 214b can be used to page backward or forward, respectively, through customer lists or other lists, for example, as represented by a stack of business cards 215. Other presentation techniques and controls can be used for selecting users, clients, customers and/or other entities, such as text entry fields and/or search features.

In addition to selection controls 212 for selecting entities for which business activities 204 are displayed, a document type control 216 can be used to select which types of business activities 204 are to be displayed. For example, as shown, an “All Documents” option 217 is selected for the document type control 216, specifying that all of the activity types, including opportunities, leads, sales quotes, sales orders, contracts, etc. are to be included in the account activity visualization 202.

In some implementations, filtering options received from the user can be used to limit the identification of the one or more business activities to entries identified according to the filtering options. For example, the user can use a filters control 218 to select filtering options, such as a time window, a monetary amount and/or a geographic area, among others, to select specific entries to be displayed in the account activity visualization 202. In some implementations, selecting the filters control 218 can cause an interface to appear in which a user can select one or more time periods (e.g., February through April) for which information is to be displayed. In another example, monetary amount filters can be used to select value ranges (e.g., contracts over $1 million). In another example, using geographic area filters, the user can select a particular city, country, continent, region, ZIP code or other geographic area. Two or more different filters can be used in combination, e.g., to produce a particular instance of the account activity visualization 202 that includes activities related to European contracts over $1 million in the month of February.

In some implementations, the account activity visualization 202 can be horizontally scrollable, for example using controls 220a and 220b for scrolling left and right, respectively. In some implementations, a user can use touch input to scroll the account activity visualization 202, e.g., by selecting the controls 220a and 220b or, using a touchpad, touching the account activity visualization 202 and sweeping the display to the left or right.

In some implementations, one or more off-screen indicators can be provided when entries in the account activity visualization are truncated from being displayed because of display size limitations. For example, ellipses 222a can be displayed to indicate that scrolling to the left can occur, and ellipses 222b can be displayed to indicate that scrolling to the right can occur. In some implementations, a current day indicator 224 can indicate the current day on the timeline.

Some implementations include a gadget area 226, e.g., for displaying information that is complimentary to information displayed in the account activity visualization 202. For example, the user can drag an entry (e.g., one of the business activities 204) to the gadget area 226 (e.g., onto an add gadget control 228) for displaying detail. In some implementations, a display can appear within the gadget area 226 that includes detailed information corresponding to the particular business activity 204 that is dragged over. Subsequently, if the user hovers over another similar entry in the account activity visualization 202, the entry's corresponding detailed information is displayed in the gadget area 226.

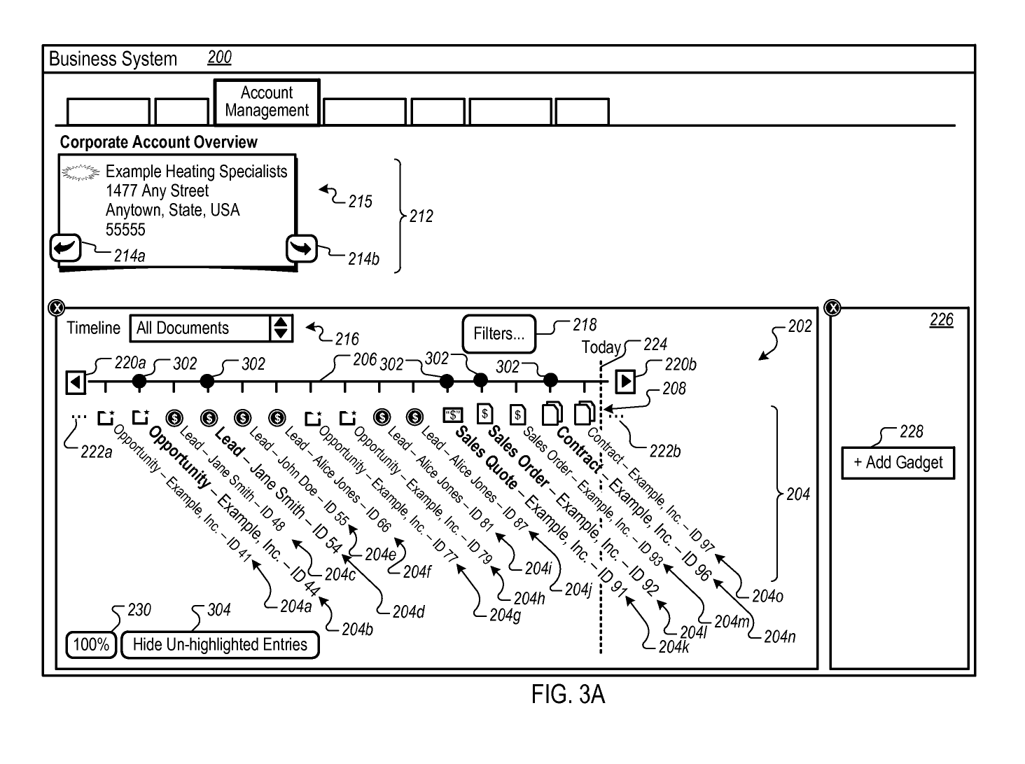

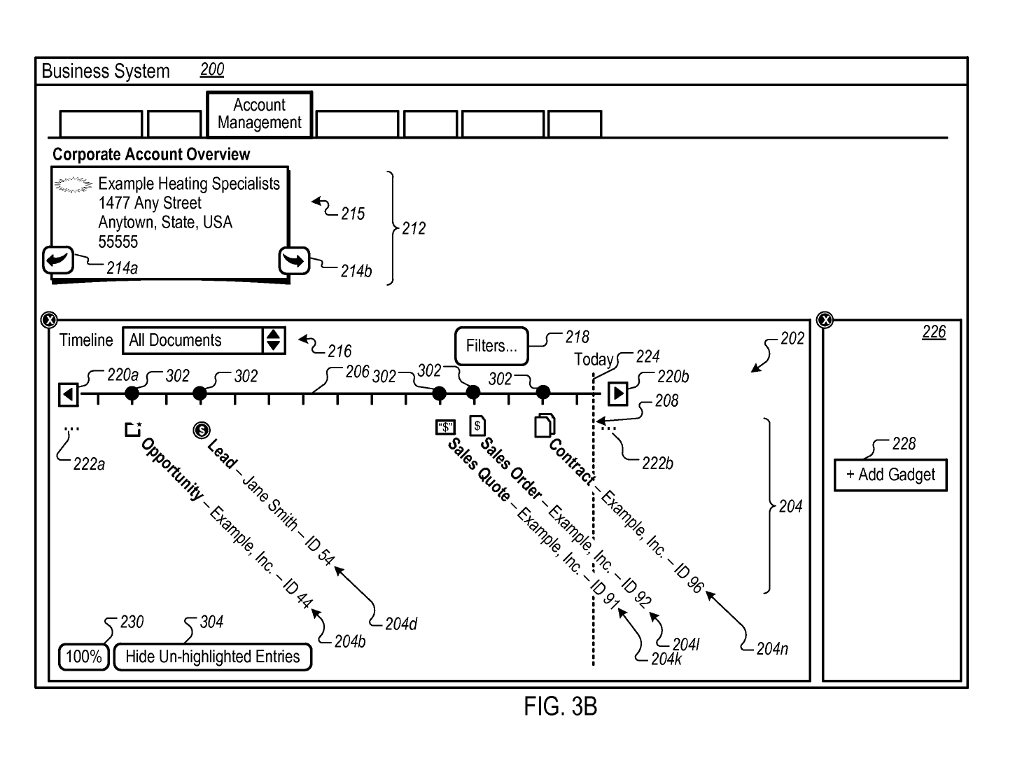

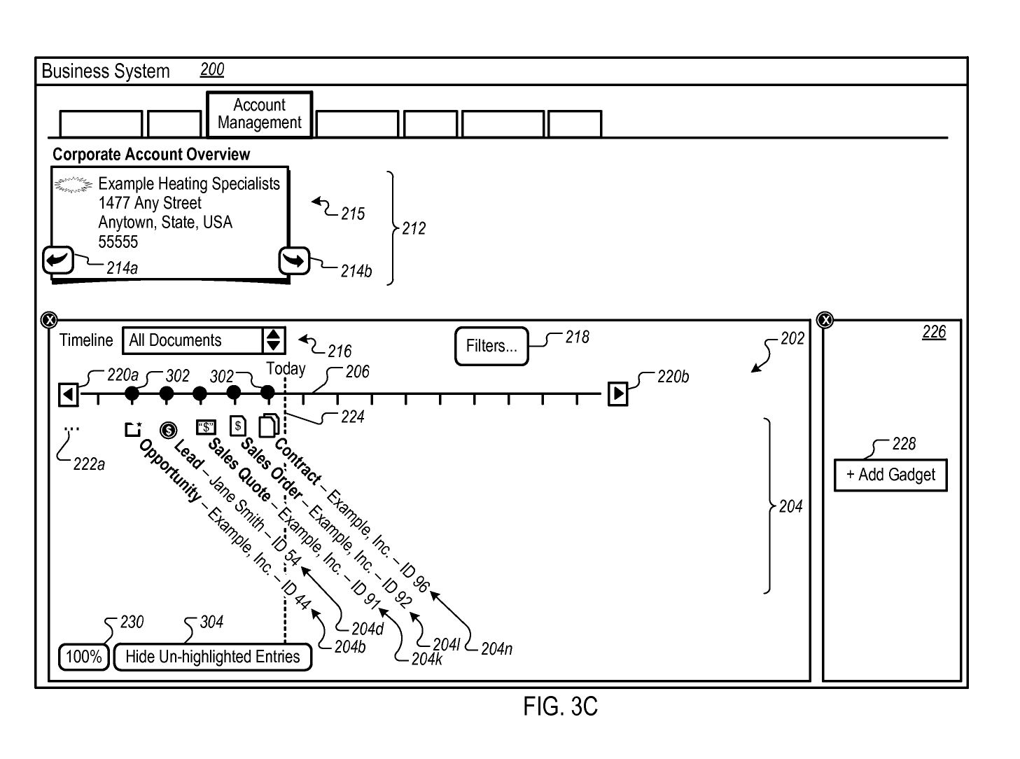

In some implementations, the display resolution of the account activity visualization 202 is resizable. For example, the user can select a control 230 to change the resolution, e.g., by a percentage, or use some other control or mechanism for changing the resolution. As a result of changing the resolution, the amount of entries displayable in the timeline can change. In some implementations, changing the resolution, e.g., on a multi-touch display, can include zooming in and out using pinch-in, pinch-out, and/or other techniques. Each zoom-in level can have a different opacity threshold and/or other result. For example, zooming in a partial amount can fade out the non-relevant elements to 50% or other percentage opacity (e.g., as shown in FIG. 3B, with non-relevant elements deleted). In another example, zooming in further can hide those elements completely and result in displaying a compressed view, e.g., as shown in FIG. 3C. The result can economize available space and make use of newly empty space of the hidden elements. In some implementations, tapping a 100% button or some other control can reset the display, e.g., to that of FIG. 3A.

FIG. 3A is another example illustration of the example interface 200 that changes the display of the account activity visualization 202 based on a user selection. For example, the user can use touch input or some other way to make a selection of a particular business activity from the displayed account activity visualization 202. As a result of the selection, at least one of the one or more business activities 204 is identified as being related to the selected particular business activity. Further, the selected business activity and the at least one related business activities are visually distinguished from the non-selected and non-related business activities to indicate their relation in the account activity visualization.

For example, if the user selects the business activity 204n, e.g. identifying a contract with Example, Inc. and having an identifier 96, then related business activities 204b, 204d, and 204k-204l can be automatically identified. Together, those business entries can represent a user-selected path of business activity. In some implementations, identification of the related business activities can occur by matching identifiers of the business activities, e.g., information stored for a particular contract may include identifiers of previous and/or related business activities. After the related business activities are identified, the selected business activity 204n and the related business activities 204b, 204d, and 204k-204l can be visually distinguished. In some implementations, visually distinguishing the related business activities can include highlighting, color-coding, bolding and/or resizing, or markers 302 for the highlighted entries can be placed on the timeline 206. In some implementations, entries in the timeline that are not the highlighted business activities 204n, 204b, 204d, and 204k-204l can be un-highlighted in some way, e.g., by reducing font sizes, by graying out the entries, or in other ways. For example, in FIG. 3A, business entries 204 that are not part of the user-selected path have a smaller font size.

In some implementations, relationships among business activities can be defined in one or more object models and based on definitions of related business objects. For example, an object model for a contract can include relationships to other business objects, e.g., opportunities, leads, sales quotes, sales orders, and other business objects related to the contract business object. As a result, when the user selects a particular business activity, information from related object models can be used to identify the related business activities.

In the example shown, the visually distinguished (as illustrated, highlighted) business activities 204n, 204b, 204d, and 204k-204l are presented with the non-visually distinguished (i.e., highlighted) business activities. In some implementations, information can be hidden based on certain user selections. For example, in response to a user selection of a hide control 304, the account activity visualization 202 can be updated to hide entries not included in the selected business activity 204n and the related business activities 204b, 204d, and 204k-204l. At this time, other related entries to the left of business activity 204b can also be pulled into the display, e.g., if not already displayed due to space considerations. In some implementations, when entries are hidden, the hide control 304 can automatically turn into and be labeled as an unhide control. Subsequently, in response to a user selection of the unhide control, the account activity visualization 202 can be updated to restore the hidden entries. Other hide and unhide controls can also exist, e.g., on a per-entry basis or to hide certain types of business activities.

In some implementations, when entries are visually distinguished or otherwise emphasized, the visual distinguishing can include highlighting and/or using different display sizes of business activities, each display size representing an importance of the corresponding business activity. For example, a lead business activity can be presented with a larger size than an opportunity in the same path.

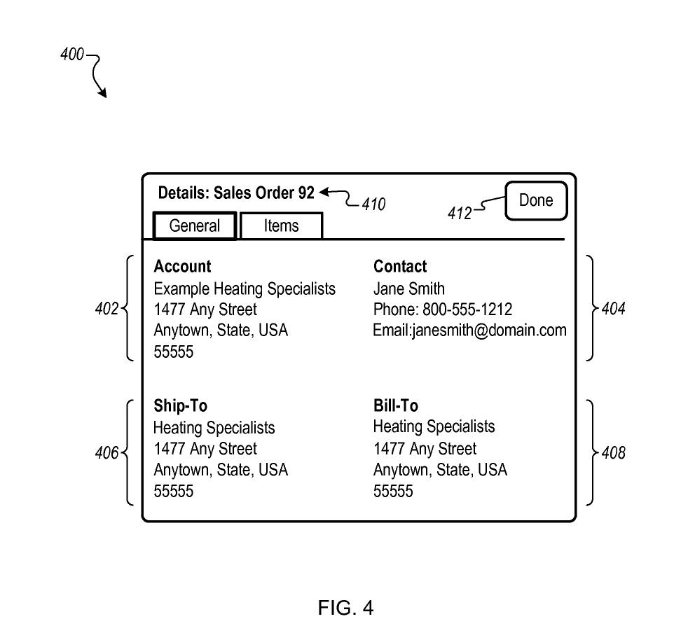

FIG. 4 is an example illustration of an example details display 400 for an entry in the account activity visualization 202. For example, the details display 400 (e.g., for a Sales Order having the ID 92) can be presented if the user uses a control associated with a corresponding business activity 204 (e.g., business activity 204l for the sales order for Example, Inc.). In some implementations, the details display 400 can be displayed in different ways, e.g., by selecting (e.g., clicking on) a business activity 204, by selecting the corresponding symbol 208. In some implementations, the details display 400 can be displayed as a pop-up display over or adjacent to the account activity visualization 202. In some implementations, the information can be displayed in a different area within the interface 200.

In this example, the details display 400 includes four data groupings related to the sales order, e.g., account data 402, contact data 404, ship-to information 406 and bill-to information 408. A details display header 410 can identify the header information for the business activity 204l. Other information can be included in the details display 400. In some implementations, e.g., when the details display 400 is presented as a pop-up, a done control can be used to dismiss the pop-up.

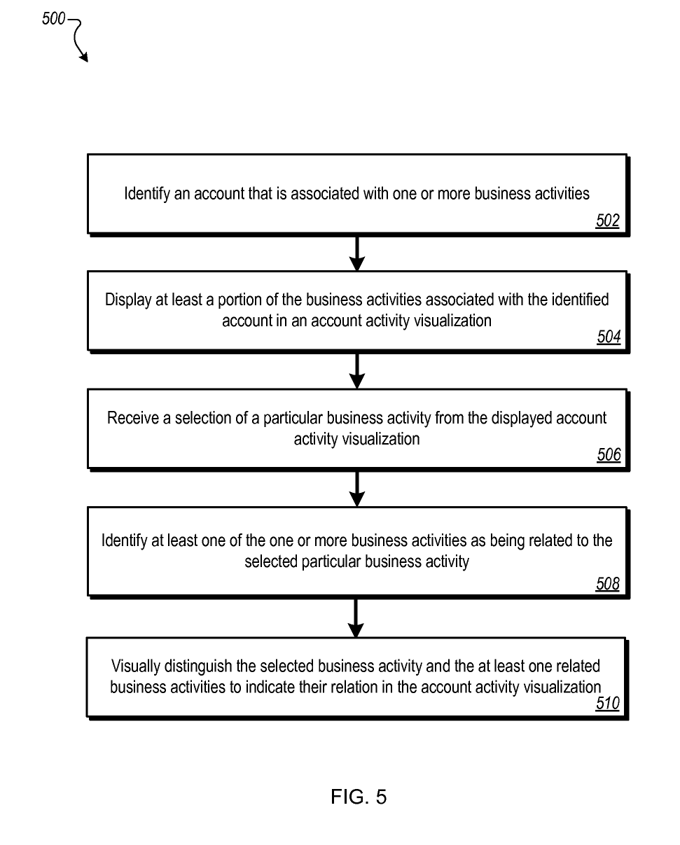

FIG. 5 is a flowchart of an example method 500 for creating an account activity visualization. For clarity of presentation, the description that follows generally describes method 500 in the context of FIGS. 1-3. However, it will be understood that method 500 may be performed, for example, by any other suitable system, environment, software, and hardware, or a combination of systems, environments, software, and hardware, as appropriate.

At 502, an account is identified, where the identified account is associated with one or more business activities. Each business activity can be associated with at least one of a user, a client and/or a customer. For example, the user may select a particular account from selection controls 212, from a list of accounts, or by typing an account identifier in a text control.

At 504, at least a portion of the business activities associated with the identified account are displayed in an account activity visualization. As an example, the account activity visualization 202 can be displayed, including business activities 204 that are associated with the identified account.

At 506, a selection of a particular business activity is received from the displayed account activity visualization. For example, the user can select the business activity 204n that is associated with a contract with Example, Inc.

At 508, at least one of the one or more business activities is identified as being related to the selected particular business activity. As an example, the related business activities engine 136 can identify business activities 204b, 204d, and 204k-204l as being related to the business activity 204n.

At 510, the selected business activity and the at least one related business activities are visually distinguished or otherwise emphasized to indicate their relation in the account activity visualization. For example, referring to FIG. 3A, business activities 204n, 204b, 204d, and 204k-204l can be highlighted to show their relationship and to differentiate those business activities from the other business activities 204.

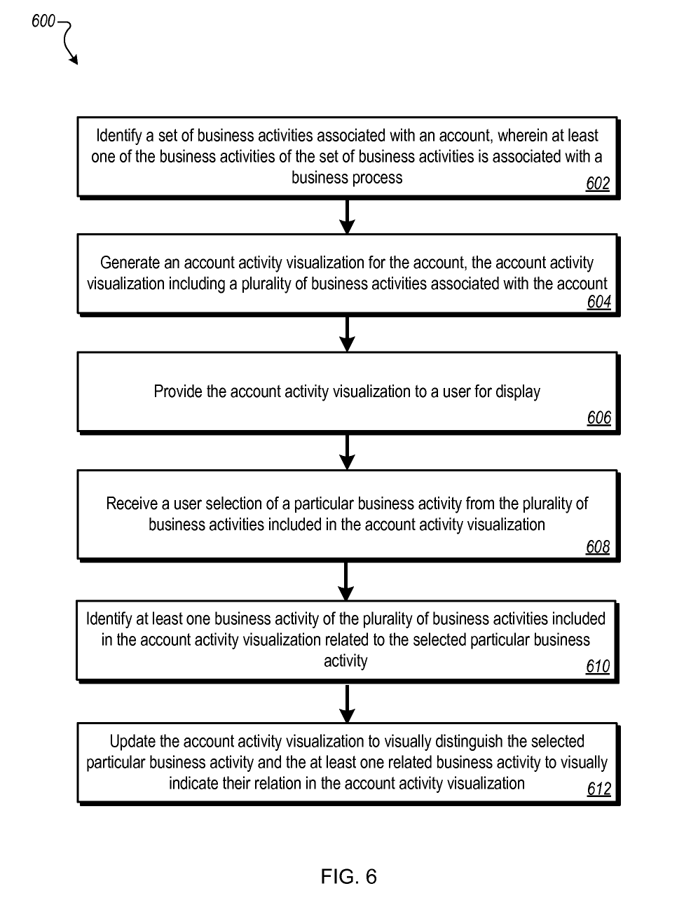

FIG. 6 is a flowchart of another example method 600 for creating an account activity visualization. For clarity of presentation, the description that follows generally describes method 600 in the context of FIGS. 1-3. However, it will be understood that method 600 may be performed, for example, by any other suitable system, environment, software, and hardware, or a combination of systems, environments, software, and hardware, as appropriate.

At 602, a set of business activities associated with an account is identified, where at least one of the business activities of the set of business activities is associated with a business process. As an example, the application server engine 132 can identify business-related activities that correspond to a particular account selected or identified by a user using the device 140.

At 604, an account activity visualization is generated for the account, and the account activity visualization includes a plurality of business activities associated with the account. For example, the account visualization engine 134 can create the account activity visualization 202.

At 606, the account activity visualization is provided to a user for display. As an example, the application server engine 132 can provide the account activity visualization 202 a user using the device 140.

At 608, a user selection is received of a particular business activity from the plurality of business activities included in the account activity visualization. For example, the user can select the business activity 204n that is associated with a contract with Example, Inc.

At 610, at least one business activity is identified from the plurality of business activities included in the account activity visualization related to the selected particular business activity. As an example, the related business activities engine 136 can identify business activities 204b, 204d, and 204k-204l as being related to the business activity 204n.

At 612, the account activity visualization is updated to visually distinguish the selected particular business activity and the at least one related business activity to visually indicate their relation in the account activity visualization. For example, referring to FIG. 3A, business activities 204n, 204b, 204d, and 204k-204l can be highlighted to show their relationship and to differentiate those business activities from the other business activities 204.

In some implementations, information associated with related business activities and/or the account activity visualization can be used in other ways. For example, the set of related business activities can be exported and used in different types of reports. Further, there may be information associated with activities that is not presented in a timeline, e.g., in the account activity visualization 202. In some implementations, additional information associated with business activities can be presented to the user in other ways, such as in popups or other parts of a user interface. For example, other information presented to a user in popups can include notes, the names and/or information for users, documents, and/or other information associated with the business activities. The user may view the information, for example, by selecting one or more activities in the timeline, by selecting display options in the user interface, or in other ways.

The preceding figures and accompanying description illustrate example processes and computer implementable techniques. But environment 100 (or its software or other components) contemplates using, implementing, or executing any suitable technique for performing these and other tasks. It will be understood that these processes are for illustration purposes only and that the described or similar techniques may be performed at any appropriate time, including concurrently, individually, or in combination. In addition, many of the steps in these processes may take place simultaneously, concurrently, and/or in different orders than as shown. Moreover, environment 100 may use processes with additional steps, fewer steps, and/or different steps, so long as the methods remain appropriate.

In other words, although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A computer-implemented method comprising:
identifying a set of business activities associated with an account, wherein at least one of the business activities of the set of business activities is associated with a business process;
generating an account activity visualization for the account, the account activity visualization including a plurality of business activities associated with the account;
providing the account activity visualization to a user for display;
receiving a user selection of a particular business activity from the plurality of business activities included in the account activity visualization;
identifying at least one business activity of the plurality of business activities included in the account activity visualization related to the selected particular business activity; and
updating the account activity visualization to visually distinguish the selected particular business activity and the at least one related business activity to visually indicate their relation in the account activity visualization.

2. The method of claim 1, wherein the at least one related business activity and the particular business activity are associated with a same business process.

3. The method of claim 1, wherein each business activity has an activity type and wherein the at least one related business activity and the particular business activity have a same activity type.

4. The method of claim 1, wherein a respective one of the plurality of business activities includes a name, an identifier and an icon indicating an activity type of the respective business activity.

5. The method of claim 1, wherein the user selection is received in response to a touch input.

6. The method of claim 1, wherein the plurality of business activities in the account activity visualization are arranged in chronological order.

7. The method of claim 1, wherein the visually distinguished selected particular business activity is presented with non-visually distinguished business activities.

8. The method of claim 1, wherein updating the account activity visualization to visually distinguish the selected particular business activity and the at least one related business activity includes highlighting, color-coding, bolding and/or resizing of the selected particular business activity and the at least one related business activity.

9. The method of claim 1, further comprising:
updating the account activity visualization to hide entries not included in either of the selected particular business activity or the at least one related business activities in response to a user selection of a hide control; and
updating the account activity visualization to restore the hidden entries in response to a user selection of an unhide control.

10. The method of claim 1, wherein generating an account activity visualization includes generating information for annotating text or icon size in an initial display of the account activity visualization to indicate various levels of importance or monetary value of the business activities.

11. The method of claim 1, wherein updating the account activity visualization includes adjusting display sizes of the selected particular business activity and the at least one related business activity, each display size representing a pre-determined importance of the corresponding business activity.

12. The method of claim 1, wherein generating an account activity visualization includes generating a timeline with a plurality of entries corresponding to the plurality of business activities, and wherein entries in the timeline are displayed diagonally off of the timeline.

13. The method of claim 1, wherein the account is associated with at least one of a user, a client, and a customer.

14. The method of claim 1, further comprising:
providing one or more off-screen indicators when entries in the account activity visualization are truncated from being displayed because of display size limitations.

15. The method of claim 1, further comprising:
receiving selection of at least one filtering option from the user, and wherein identifying the at least one of the one or more business activities as related to the selected particular business activity includes resizing the visualization or presenting a limited visualization based on the selected at least one filtering option.

16. The method of claim 15, wherein the filtering options include at least one of a time window, a monetary amount, a geographic area, and an activity type.

17. The method of claim 1, wherein the account activity visualization includes a gadget area, and wherein an entry can be dragged to the gadget area for displaying detail, and wherein hovering over other similar entries in the account activity visualization causes their detail to be displayed in the gadget area.

18. The method of claim 1, wherein the account activity visualization includes entries, each entry including information associated with a particular business activity, the information including one or more types of information selected from a group comprising an activity type, a customer name, a contact name or a unique identifier.

19. A system comprising:
one or more computers associated with business-related activities; and
a computer-readable medium coupled to the one or more computers having instructions stored thereon which, when executed by the one or more computers, cause the one or more computers to perform operations comprising:
identifying a set of business activities associated with an account, wherein at least one of the business activities of the set of business activities is associated with a business process;
generating an account activity visualization for the account, the account activity visualization including a plurality of business activities associated with the account;
providing the account activity visualization to a user for display;
receiving a user selection of a particular business activity from the plurality of business activities included in the account activity visualization;
identifying at least one business activity of the plurality of business activities included in the account activity visualization related to the selected particular business activity; and
updating the account activity visualization to visually distinguish the selected particular business activity and the at least one related business activity to visually indicate their relation in the account activity visualization.

20. A computer-program product, the computer program product comprising computer-readable instructions embodied on tangible, non-transitory media, the instructions operable when executed by at least one computer to:
identify a set of business activities associated with an account, wherein at least one of the business activities of the set of business activities is associated with a business process;
generate an account activity visualization for the account, the account activity visualization including a plurality of business activities associated with the account;
provide the account activity visualization to a user for display;
receive a user selection of a particular business activity from the plurality of business activities included in the account activity visualization;
identify at least one business activity of the plurality of business activities included in the account activity visualization related to the selected particular business activity; and
update the account activity visualization to visually distinguish the selected particular business activity and the at least one related business activity to visually indicate their relation in the account activity visualization.
